(19) United States
(12) Patent Application Publication
(10) Pub. No.: US 2013/0110608 A1
(43) Pub. Date: May 2, 2013

(54) Method for Incentivizing Network-Connected Consumers Patronizing a Network-Hosted Shopping Site

(71) Applicants: Sukhinder Singh Cassidy, Atherton, CA (US); Diana Lynn Williams, Burlingame, CA (US); Sin-Mei Tsai, Cupertino, CA (US)

(72) Inventors: Sukhinder Singh Cassidy, Atherton, CA (US); Diana Lynn Williams, Burlingame, CA (US); Sin-Mei Tsai, Cupertino, CA (US)

(21) Appl. No.: 13/286,453

(22) Filed: Nov. 1, 2011

(51) Int. Cl. G06Q 30/02

(52) U.S. Cl. 705/14.27

(57) ABSTRACT

A method for incentivizing network-connected consumers patronizing a network-hosted shopping site includes the steps (a) establishing a ratio between points and monetary credit, (b) assigning points to individual product representations, product groupings, and web-based actions performed by consumers, (c) creating point value accounts for qualified consumers, (d) tracking actions and transactions completed by consumers, (e) calculating accounting data relative to point accumulation and consumption by consumers resulting from the actions and transactions of step (d), and (f) displaying the data in summary form to consumers.

### BACKGROUND OF THE INVENTION

1. Field of the Invention

The present invention is in the field of ecommerce and pertains particularly to methods and apparatus for incentivizing consumers and potential consumers to patronize a network-based shopping site.

2. Discussion of the State of the Art

In the field of ecommerce, more particularly, online shopping, retail shopping portals exist where consumers can purchase products and related services over the Internet using credit or online accounts. Many online services and shopping sites have rewards programs for rewarding consumer loyalty by providing discounts on goods and services. Travel programs offer free miles, other retail sites offer points that accumulate over time and can be redeemed for certain goods and services. A problem with these programs is that they are generic. That is to say that points are relative only to the amount of money spent and accumulate proportionally with each monetary purchase.

Too often, some pre-set threshold exists relative to the required number of points that must be accumulated before they can be used to obtain a discount. Many times consumers do not buy enough to accumulate enough points to make it worth their while. Moreover, many companies have set an expiration period for points where if not redeemed in a timely manner they expire and are no longer relevant. Consumers desire more flexible incentives that they can help shape to best fit their situation or lifestyle.

Therefore, what is clearly needed is a method for incentivizing network-connected consumers patronizing a network-hosted shopping site that is more flexible and that may be optimized by the consumer.

### SUMMARY OF THE INVENTION

The problem stated above is that incentivizing consumers and potential consumers to patronize a network-based shopping site is desirable for the site-hosting company, but many of the conventional means for creating incentives, such as points loyalty programs, also create inflexibility. The inventors therefore considered functional elements of a network-based shopping site, looking for elements that exhibit interoperability that could potentially be harnessed to provide incentives to consumers, but in a manner that would not create further inflexibility.

Every web-based shopping portal is driven by consumers, one by-product of which is a healthy consumer base that routinely patronizes the shopping site. Most such shopping portals employ network-connected servers and software to conduct the business of the company on the website, and servers running software are typically a part of such apparatus.

The present inventor realized in an inventive moment that if, at the point of contact, consumers could be incentivized to make purchases and to, in some instances, represent the company by proxy, significant increases in sales and consumer loyalty might result. The inventor therefore constructed a unique method for incentivizing consumers and potential consumers of an online shopping portal that allowed consumers a number of different ways to earn points through the site including performing transactions. In one embodiment, the software includes a further function for calculating account data relative to accumulation and consumption by consumers of points equated to monetary credit, the points assigned in specified amounts to individual product representations, product groupings, and web-based actions that are contemplated, but not yet undertaken, the calculation serving as a prediction of monetary credit ordered relative to the contemplated web-based actions upon request. A significant uptick in successful transactions and consumer loyalty results, with no impediment to efficiency or quality of service (QOS) created.

Accordingly, in an embodiment of the present invention, a method for incentivizing network-connected consumers patronizing a network-hosted shopping site is provided and includes the steps (a) establishing a ratio between points and monetary credit, (b) assigning points to individual product representations, product groupings, and web-based actions performed by consumers, (c) creating point value accounts for qualified consumers, (d) tracking actions and transactions completed by consumers, (e) calculating accounting data relative to point accumulation and consumption by consumers resulting from the actions and transactions of step (d), and (f) displaying the data in summary form to consumers.

In one aspect of the method, the network is the Internet network. In one aspect, in step (a), monetary credit is expressed in US currency. In one aspect, in step (b), individual product representations are denoted by stock keeping units (SKUs). In one aspect, in step (b), the product groupings are logical groupings of product representations. In one aspect, in step (d), web-based actions include completing transactions, member referrals, consumer registrations, consumer video appearances, consumer reviews, and consumer navigation tasks.

In one aspect of the method, in step (c), the created accounts are linked to one or more consumer interfacing applications operated by identified consumers. In one aspect, in step (d), actions and transactions are tracked in real time as they occur. In one aspect, in step (e), the data is rendered in objective fashion in cases of actual actions and transactions completed, and in predictive fashion in cases of contemplated actions and transactions. In one aspect, in step (f), the data is displayed in one or more of a Website, a video, a product page, a checkout page, a popup notification and, an electronic message.

According to one embodiment of the present invention, a system for incentivizing network-connected consumers patronizing a network-hosted shopping site is provided and includes an Internet-connected server, software executing from a non-transitory physical medium the software providing functions for tracking web-based actions completed by consumers, calculating account data relative to accumulation and consumption by consumers of points equated to monetary credit, the points assigned in specified amounts to individual product representations, product groupings, and web-based actions, and displaying the data in summary form to consumers.

In one embodiment, monetary credit is expressed in US currency. In one embodiment, web-based actions include completing transactions, member referrals, consumer registrations, consumer video appearances, consumer reviews, and consumer navigation tasks. In one embodiment, the data is displayed in one or more consumer interfacing applications operated by identified consumers. In one embodiment, the web-based actions and transactions are tracked in real time as they occur. In one embodiment, individual product representations are denoted by stock keeping units (SKUs). In one embodiment, the product groupings are logical groupings of product representations.

In one embodiment, the consumer interfacing applications include one or more of a Website, a video, a product page, a checkout page, a popup notification and, an electronic message. In one embodiment, the software includes a further function for calculating account data relative to accumulation and consumption by consumers of points equated to monetary credit, the points assigned in specified amounts to individual product representations, product groupings, and web-based actions that are contemplated, but not yet undertaken, the calculation serving as an ordered prediction of monetary credit relative to the contemplated web-based actions. In this embodiment, the web-based actions are contemplated transactions to purchase one or more products.

### BRIEF DESCRIPTION OF THE DRAWING FIGURES

FIG. 1 is an architectural overview of a communications network supporting a point-based consumer incentive program for an ecommerce shopping site according to an embodiment of the present invention.

FIG. 2 is a plan view of a data table depicting point program data associations.

FIG. 3 is a plan view of a personalized start page supporting acquisition and distribution of earned points.

FIG. 4 is a plan view of a visitor welcome page depicting a points program incentivizing advertisement.

FIG. 5 is a plan view of a personalized summary page detailing points usage.

FIG. 6 is a block diagram depicting a points optimization engine for evaluating points associations to compared products.

FIG. 7 is a process flow chart depicting steps for applying points to a purchase.

FIG. 8 is a process flow chart illustrating steps for comparing point values of similar products to optimize savings.

### DETAILED DESCRIPTION

The inventors provide a system and methods for leveraging a points program to help incentivize consumers who patronize an ecommerce sales website. The present invention is described in enabling detail using the following examples, which may describe more than one relevant embodiment falling within the scope of the present invention.

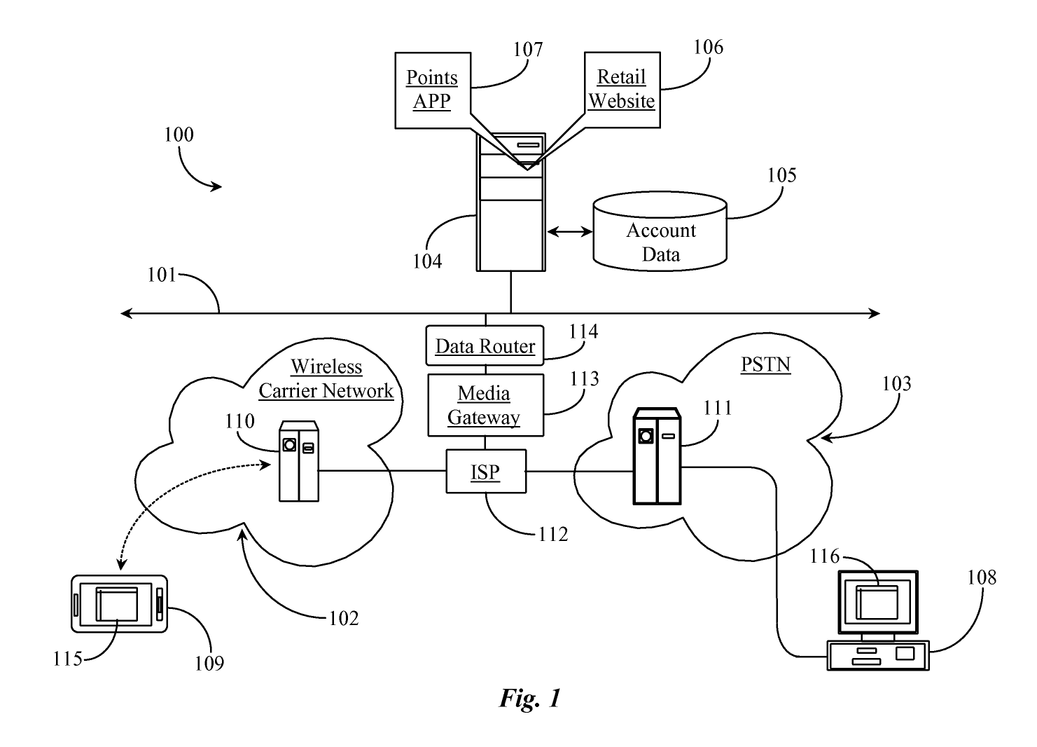

FIG. 1 is an architectural overview of a communications network 100 supporting a point-based consumer incentive program for an ecommerce shopping site according to an embodiment of the present invention. Communications network 100 includes a wide-area-network (WAN) represented herein by a network backbone 101. In a preferred embodiment, the WAN is the Internet network and backbone 101 represents all of the lines, equipment, and connection points that make up the Internet as a whole, including any connected sub-networks. Therefore, there are no geographic limitations to the practice of the present invention. WAN 101 may be referred to in this specification as Internet 101 reflecting the preferred application of the present invention to online ecommerce shopping websites.

Internet 101 supports a web server 104. Web server 104 is adapted as a web page server and includes a non-transitory physical medium containing all of the data and software required to enable server 104 to serve web pages to connected consumers. Server 104 may be maintained by an ecommerce business or by a third party host without departing from the spirit and scope of the present invention. Server 104 hosts an ecommerce retail website 106. Retail website 106 is, in a preferred embodiment, a fully functional shopping portal. Website 106 is accessible by universal resource locator (URL) to any connected consumer typing the URL into a browsing application. Website 106 may contain many web pages, including a start page, product pages, media pages, social interaction pages, help pages, a checkout page, etc.

Server 104 also hosts a points application 107 configured to website 106. Points application 107 includes components or tools that are adapted for establishing a ratio between points and currency, assigning points to product representations (sales items), logical product groupings (multiple item sales), and specified web-based actions that might be performed by consumers who patronize website 106. Points application 107 may also include components or tools for tracking actions and transactions made by consumers while navigating website 106, calculating accounting data relative to point accumulation and consumption by those consumers, and provision of summary and detailed information to individual consumers relative to their points accounts.

Website 106 supports full multimedia communications and may be linked to other support services like a call center for telephone-based sales and service. However, in this example consumers like one operating from computer 108 may interact fully with website 106 to review and purchase products or services without using a telephone.

Consumers have access to server 104 and website 106 through a variety of network connection methods. In this example, two consumers are represented by a personal computer (PC) 108 and by a smart phone 109. A consumer operating computer 108 aided by a browser application 116 may connect to network 101 through a public switched telephone network (PSTN) 103, a local telephony switch 111, and Internet Service Provider (ISP) 112, a media gateway 113, and a data router 114.

A consumer operating smart phone 109 aided by a browser application 115 may access network 101 via a wireless carrier network 102, a telephony switch 110, ISP 112, media gateway 113, and data router 114. Internet-capable appliances other than a smart-phone or a PC may also be used by consumers to access network 101, such as an android device, a personal digital assistant, a gaming station, an iPAD, a Laptop, or any other network-capable appliance aided by a browsing application.

In use of the present invention, a consumer operating PC 108 aided by browser application 116 may navigate to and connect website 106 hosted by server 104. Once connected to website 106, the consumer may login to the website if he or she is a registered member of the website. If the consumer is a new user or a first time visitor, the consumer may register with the website. Consumers have access to personalized point-based accounts. Point-based accounts are created for registered consumers as a way to incentivize those consumers to interact more with website 106.

Points application 107 is unique in that in addition to assigning points for purchases of certain items, the application may also enable assignment of points to business friendly website actions. Such points may be used in several ways. Points may be used as currency in the purchase of products. Points may be transferred to other supported opportunities in one embodiment, such as using them for travel, to buy advertising, or to perform some other supported function the site might host. In one embodiment, earned points may be redeemed for credit against activities like travel, buying gift certificates, converting points to other reward programs, requesting video appearances, or engaging in fashion or lifestyle consultations, etc. In one embodiment, there may be an expiration date on points earned so that consumers do not build huge accounts of unused points over time.

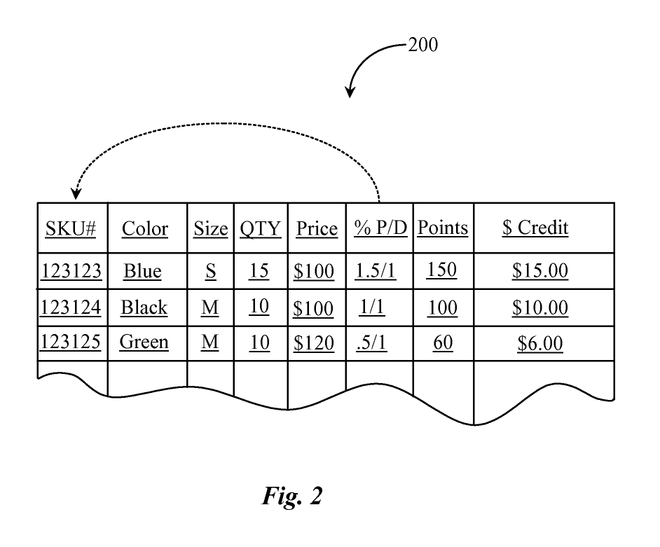

FIG. 2 is a plan view of a data table 200 depicting point program data associations. Data table 200 is arranged in columns and rows and provides information about how points are assigned and how points correlate to currency according to one embodiment of the present invention. Table 200 contains several columns. Reading from left to right, the first column is labeled Stock Keeping Unit number (SKU#). Many retail operations keep track of inventory using SKU numbers to uniquely identify products. In one embodiment, the ecommerce website promotes fashion products. In this example, the fashion products each have unique SKU numbers assigned to them. SKU#123123, for example, is a fashion product that has a specific color, and a specific size. This data is revealed under columns 2 and 3 reading from left to right. A fourth column is labeled quantity (QTY). In the first row for SKU number 123123, there is a quantity of 15 available for purchase.

A fifth column is labeled price. For SKU number 123123, the price per unit is $100.00. A sixth column labeled percentage of points/dollar (% P/D). For SKU number 123123, 1.5 points are assigned for every dollar of price. A seventh column is labeled points and provides the total amount of points that may be earned on the purchase of SKU 123123. In this example it is 150 points. If the total price for SKU number 123123 was $50.00, then the total amount of earnable points would be 75 points. In this example, a point has a 10:1 ratio to currency. Also in this example, the currency is the US dollar. Therefore, an accrual of 150 points for purchase of SKU number 123123 equals a credit of $15.00 as a reward for making the purchase.

It is noted herein that different product representations (SKUs) may have different point percentages assigned to them. Such assignments may be made manually or may be controlled automatically based on sales expectations and cost factors such as wholesale price, overhead, and so on. For example, it may be prudent to assign a higher point percentage to a product that is not moving as well as another product with a lower point percentage. The next row down depicts SKU 123124 in the color black, size medium (M), QTY 10. The price is $100.00 and the point percentage assigned is one point per dollar. Therefore, 100 points may be accrued for the purchase of this product equaling $10.00 in monetary credit to the consumer. This tabled data may reside in a searchable data repository so that the points application may automatically retrieve the information at the time of review or purchase.

In one embodiment of the present invention, the points application analogous to application 107 of FIG. 1 enables consumers to run the points values for their planned purchases before taking them to checkout. Consumers may manually mix and match fashions for multi-item purchases to optimize the points value that may be accrued for the purchase. In one embodiment, the Points application is enhanced with a points optimization engine that may automatically search in an SKU repository for products that are comparable to products planned for purchase that may have a higher point percentage assigned to them. More detail about such an optimization engine will be provided later in this specification.

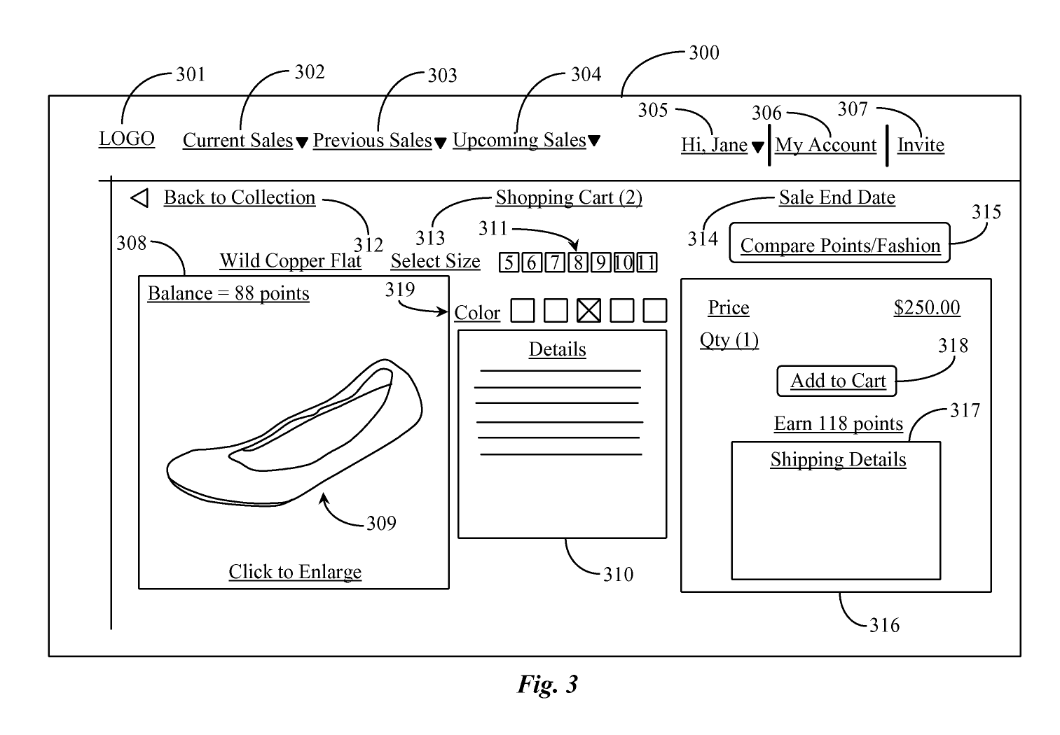

FIG. 3 is a plan view of a personalized start page 300 supporting acquisition and distribution of earned points. Start page 300 is personalized to a consumer called Jane in this example. A greeting 305 reading Hi, Jane is provided in the title bar of the page after consumer log-in and identification. Jane may review her point account by clicking on hypertext 306 labeled My Account to navigate to an account summary page depicting all the relevant details of her points account. Jane also has the opportunity to invite friends to the site for potential registration by clicking hypertext 307 labeled Invite. In an embodiment of the present invention, points may be assigned to the action invite.

Page 300 includes a company LOGO 301. A dropdown menu 302 is provided on page 300 that lists all of the current sales being promoted at the site. A dropdown menu 303 is provided on page 300 that lists previous sales promoted by the site in the past. A dropdown menu 304 is provided on page 300 that lists all of the upcoming sales that will be promoted by the site. A date bar 314 informs consumer Jane of the current ending data of a sale promoting items including any actively displayed items under review.

In this example, a consumer Jane is reviewing a copper colored flat 309 within an interactive viewing window 308. Viewing window 308 is a multimedia-enabled window for presenting still pictures, slideshows, and moving pictures of products associated with sales or otherwise available through the site. A back button 312 is provided on page 300 for navigating back to the previous page viewed, in this case, a collection page. Wild Copper Flat 309 may be a single product representation of a collection being reviewed by the consumer Jane.

Page 300 includes a hypertext link 313 to an active shopping cart that, in this example, contains two items placed therein by consumer Jane. Further interactive menus include a size chart 311 and a color chart 319. It is noted herein that for fashion items, each different size and color of a same style product may be denoted by a unique SKU number and may have differing point percentages assigned to them. For example, a copper flat size 5 in red may have a different SKU number than a copper flat of the same style size 7 in black. Therefore, the point percentages for each item may differ as discussed earlier in the table of FIG. 2 above.

Page 300 includes a details window 310 that contains specific product details for any item displaying in media window 308. Details may include information about the designer, the manufacturing process, materials used to make the product, and so on. Page 300 includes a window 316 that provides purchase information such as price ($250.00) for Qty (1). Window 316 displays the amount of points that would be accrued if the item were purchased. Window 316 includes a button 318 for adding the item displayed in window 308 to the shopping cart. An information box 317 provides the updated shipping information after the item is placed in the shopping cart. A total price for all items and point earned may also be displayed along with itemized lists of pricing and points accrual for each separate item of the purchase.

In this example, before consumer Jane makes a purchase, she may compare the point percentages and pricing of the items in her shopping cart or that are actively displayed in window 308 with similar products from a same or other collections by invoking link 315 labeled Compare Points/Fashion. This action calls up a points optimization engine that has access to logic for searching for products in the same fashion sense as the products under review, and logic for determining if one or more returned results might workout better for consumer Jane relative to pricing, fashion sense, and points accrual value. Such an optimization engine may be invoked to determine point percentages of single products, point percentage average for a grouping of products, and individual points accounting for items and groupings of items before a transaction has occurred.

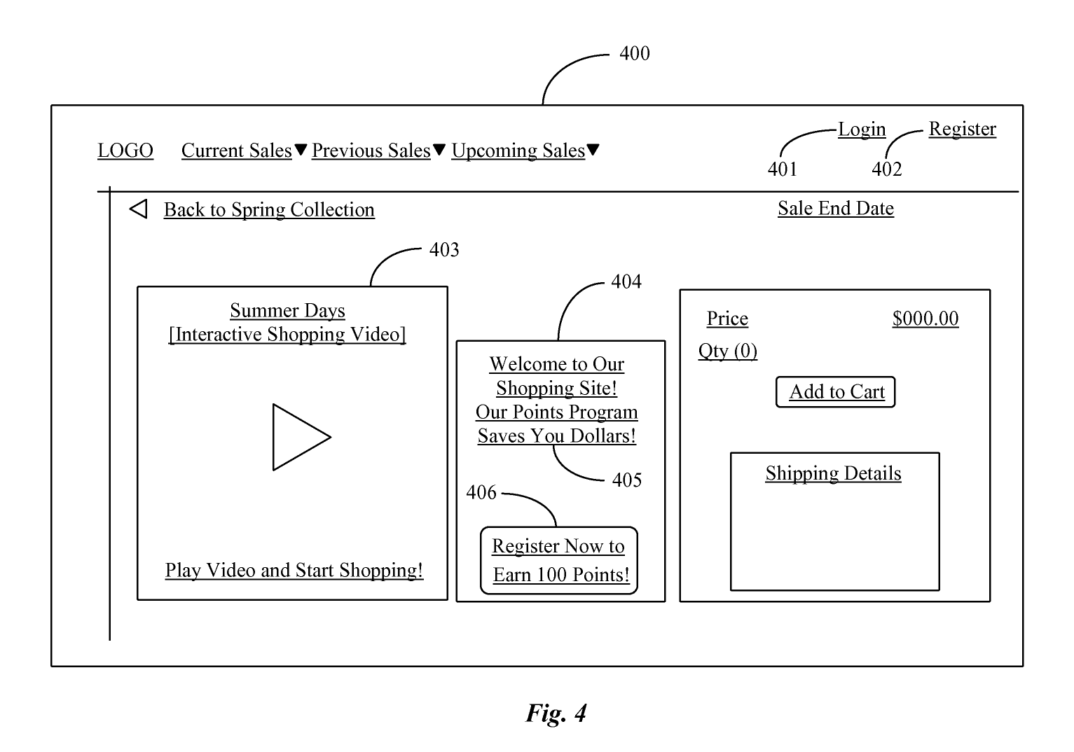

FIG. 4 is a plan view of a visitor welcome page 400 depicting a points program incentivizing advertisement. Welcome page 400 is presented to a web visitor that has not registered as a consumer and that has not been identified as yet to the ecommerce site. Page 400 may resemble personalized start page 300 without certain features resulting from log-in and identification of a consumer. In this example, page 400 includes a log-in link 401 and a registration link 402. Registration is one website action that points may be assigned to for every visitor that registers with the site so that site registration is incentivized.

In this example, a web visitor has loaded an interactive shopping video 403 labeled Summer Days. In this case, the visitor cannot earn points for purchasing because the visitor does not yet have an account. The visitor may browse products and might even be enabled to make purchases, but no points would be accrued for such transactions. Page 400 includes an information window 404 that includes a welcome message 405 welcoming the visitor and introducing the points program. In one embodiment a hypertext link may be provided within window 404 so the visitor can learn more about the program and how it works. An offer link 406 to a registration page is provided within information window 404 informing the visitor that they may earn or accrue 100 points for registering with the website thereby starting a Points account. Points accounts are, in this example, individual to consumers in a preferred embodiment. However, a Points account may also be designed for a multi-person group like a family or a group of friends.

In one embodiment, a visitor may click on the register link 406 before shopping and earn 100 points equaling $10.00 credit in a 10:1; points-to-currency ratio. Other ratios of points to currency may be observed without departing from the spirit and scope of the present invention. While a visitor may shop and purchase products without a points account in some embodiments, they may earn discount points if they register as a member of the site and will have a Points account that is automatically managed as they continue to patronize the site over time. An established point account may be linked, in a preferred embodiment to various consumer interfacing applications that may be operated by the consumers whether or not the consumers are logged into the site. Interfacing applications may include a home page, an email application, an instant messenger, a Facebook™ page and so on. Frequent reminders may be set to send Points summary information in email, short message service, instant message, or in popup notifications on any web account maintained by the consumer.

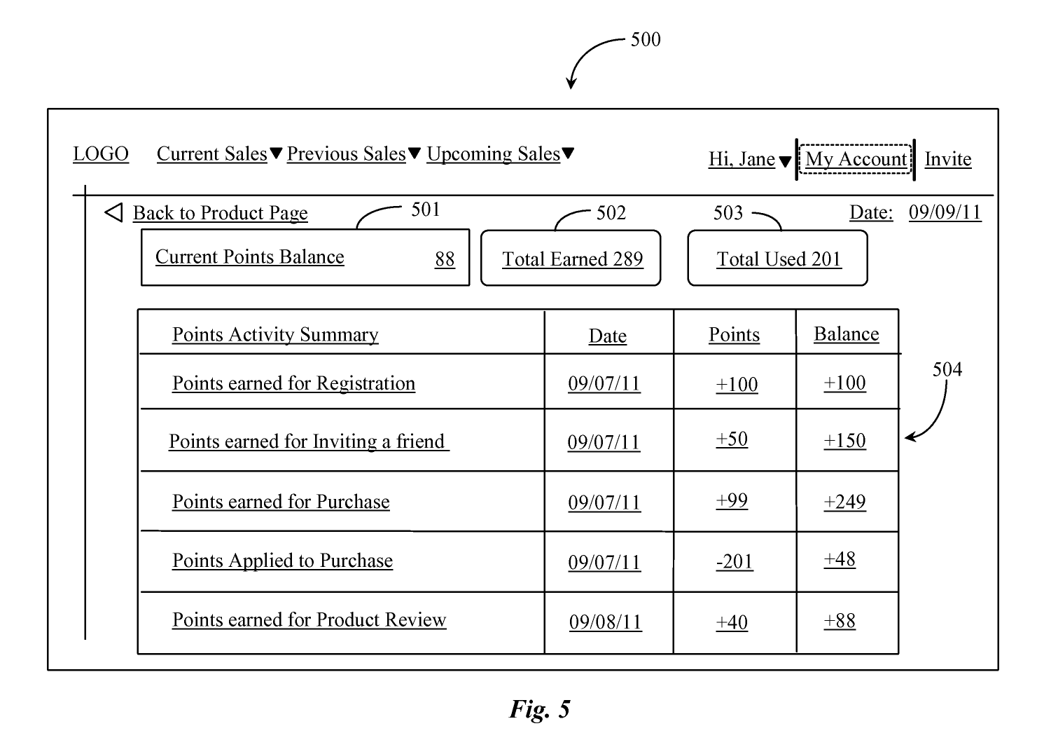

FIG. 5 is a plan view of a personalized summary page 500 detailing points usage. Summary page 500 may be served as a result of a consumer clicking on My Account. Summary page 500 includes an information block 501 containing a current points balance held by the consumer. Summary page 500 may also include an information block 502 containing the total amount of points that have been earned since registration or for a defined period of use such as by month. Summary page 500 may include an information block 503 containing the total amount of points consumed or used since registration or for a defined period. In a preferred embodiment, an accounting table 504 is provided that includes event details of Points accrual and usage. Table 504 is labeled point activity summary and includes a date column, a points accrual/usage column and a points balance column. Table 504 may be scrollable and may provide an entire record of Points accrual and usage for a consumer since inception of the account.

In this example, Points summary table 504 lists five events that occurred over a two day period since a consumer registered with the website. The consumer earned 100 points on Sep. 7, 2011 for registering with the site and setting up a points account. The consumer then earned 50 points for inviting a friend to the website on the same date. The balance column reflects the total balance at the time. The consumer then earned 99 points for engaging in a transaction to purchase one or more products on the same date. The consumer decided to use points accrued by applying them the purchase. The system updated the account in the event “Points applied to Purchase” on Sep. 7, 2011. The amount of points applied was 201 bringing the balance down to 48 points. The next day, the consumer performed a product review of the purchase to earn 40 points bring the current point balance to 88 points.

In one embodiment of the present invention, the events column contains hyperlinked text for each event description enabling the consumer to review more information like reviewing the purchase details or recalling the product review. The current point balance information may be visible to consumers on all of the pages of the website including within the shopping cart and during checkout so the consumer may always make a decision about whether to use accrued points or not. In one embodiment, the sales website may launch consumer participation campaigns where points may be accrued for certain actions like cross linking sites, telling a friend, posting advertisements or testimonials, or the like. There are many possibilities.

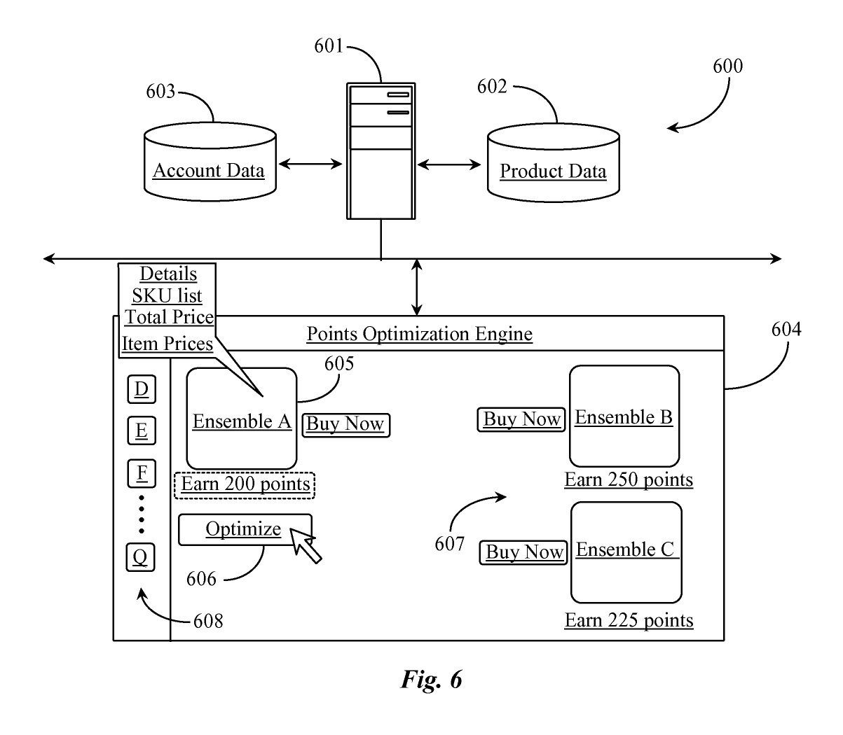

FIG. 6 is a block diagram depicting a Points optimization engine 604 for evaluating points associations to compared products. Points optimization engine 604 is, in one embodiment, a component of points application 107. Points optimization engine 604 is seen in this view as displayed on a consumer appliance used to connect to server 601. Server 601 may be analogous to server 104 of FIG. 1 or it may be another server connected to the network without departing from the spirit and scope of the present inventor. Points optimization engine 604 may be invoked, in one embodiment, as a result of a consumer interacting with the “Compare Points/Fashion” link button 315 in consumer page 300 (FIG. 3).

In this embodiment, a consumer shopping a fashion website, for example, has an ensemble A (605) comprising one or more fashion products such as a blouse, a shirt, a bag, and a pair of shoes ready for purchase. The assortment of items may be displayed in list form in window 605 or they may be visually rendered on a model, manikin, or simply arranged so that the consumer may visually see them. In this way, the consumer is empowered with visual cognition of the style, color coordination, and general look of the ensemble. In this example, the consumer will earn 200 points if she purchases ensemble A (605). A buy button is provided adjacent to window 605.

The consumer may choose to “optimize” by clicking on optimize button 606 as evidenced by the computer arrow indication selection. As a result of the action, points optimization engine 604 launches a search function on server 601. Server 601 has direct access to a product data repository 602, and to an account data repository 603. Product data repository 602 contains all of the details for each available product and for any logical product grouping promoted for sale through the website. Details may include but are not limited to complete product descriptions including SKU #, item type, brand, designer information, item size, item color, and item style. All of this information is available for each product standing alone or in a logical grouping of products.

Account data repository 603 may be analogous to repository 105 (FIG. 1). Account data repository 603 includes the consumer data and points account information for that consumer. The search function invoked by the consumer using optimization engine 604 attempts to find any items that may be substituted for items in ensemble A (605) that have a higher points value than the items currently displayed in ensemble A. Optimization engine 604 relies on fashion logic and item description including size, color, and style to determine if a same type item with a higher points value qualifies as a substitutable item. Item price may also be a factor in determining if any item qualifies as a substitutable item.

In this example, optimization engine 604 returns additional ensembles to the consumer interface. In this example, the top two ensembles in terms of points increase over the 200 points (ensemble A) are illustrated herein as ensembles 607. Ensembles 607 include ensemble B earning 250 points, and ensemble C earning 225 points. Each ensemble 607 may include one or more substituted items. The qualified substitute items are deemed by the system to be fashion appropriate when compared to the items in ensemble A subject of the search. In addition, the consumer can see the substitute items arrayed in each ensemble and make a visual comparison with ensemble A in the same workspace. This further aids the consumer in making a choice.

Other ensembles may be returned in addition to ensembles B and C and are represented herein as ensembles 608 (D, E, F, . . . Q) thumb nailed into the sidebar of the display screen of optimization engine 604. These ensembles have progressively lower point values than ensemble B and C (the top two). Total prices for the returned ensembles may also vary and may be considered in addition to point value when determining if an item qualifies as a substitute item for any item in ensemble A. The consumer may select any ensemble to purchase, but will have the option of earning more points if the consumer approves of the substituted items in the new ensemble. In one embodiment, optimization engine 604 may be used by the seller to introduce upsell products that the consumer might not notice in standalone display. New products that have not been tested may also be introduced through optimization searches driven by the consumers.

In one embodiment, Points optimization engine 604 may also be utilized by company personnel such as an authorized sales manager, etc. to determine appropriate points assignments for all of the items, item groupings, sales, and potential website actions consumers may engage in. In this embodiment, pricing logic including wholesale pricing, suggested retail pricing (SRP) and logic relative to desired profit margins for sales items and multiple item transactions may be provided to the engine to help set points assignments. The engine may be invoked automatically for a new product having suitable description including cost and SRP so the engine may suggest a point value that will incentivize a consumer but that will not eliminate or severely undermine profit margin.

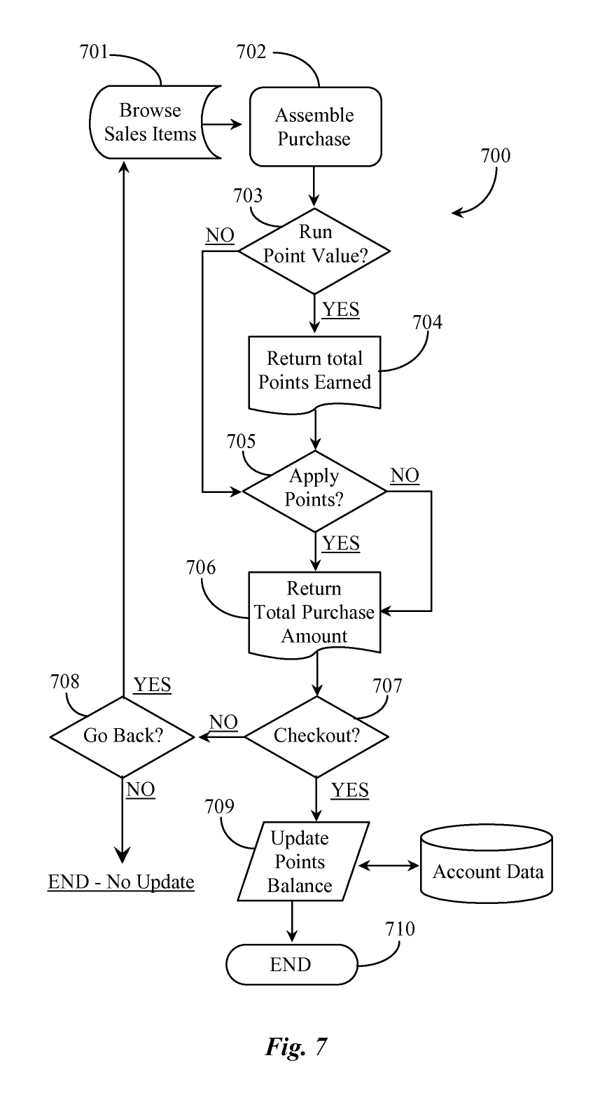

FIG. 7 is a process flow chart 700 depicting steps for applying points to a purchase. It is assumed in this process flow, that a consumer is logged into the website optimized by the points system of the present invention. At step 701, the consumer may browse sales items. The consumer assembles one or more items for a purchase transaction at step 702. In one embodiment, this is determined when the consumer has placed the one or more items in an electronic shopping cart and has proceeded to checkout.

The consumer determines at step 703 whether to run point values for the assembled items. This determination is not absolutely required in order to practice the present invention. In one aspect, the system automatically calculates the individual point values for each item and adds them. The total point value for the planned purchase may be immediately displayed to the consumer in the shopping cart utility, the calculation running as the consumer drops items in electronically. In this example, the consumer orders the point value estimation and has an option not to. In one aspect there may be a point value for the specific combination of products or for a promoted combination of products.

The point value calculation may be performed, in one embodiment, by the points optimization engine 604 described further above. If the consumer determines to run point value in step 703 for the one or more items in the shopping cart (consumer clicks a button invoking the calculation), the engine returns the total points the consumer would earn for the transaction in step 704. In one embodiment, itemized point values for each item may also be displayed to the consumer. The process then moves to step 705. If the consumer determines not to run the point value optimization at step 703, the process may skip to step 705.

At step 705, the consumer may make a determination whether or not to apply any points the consumer has in balance including those that would be earned in the pending transaction (dependent on positive checkout). Whether the consumer chooses to apply points or not at step 705, the process moves to step 706 where the system returns the total purchase amount for checkout purposes. At step 707, the consumer decides whether to proceed to checkout. If the consumer decides not to proceed to checkout, the consumer may be given the option of going back to browse sales items at step 701.

If the consumer wishes to return to the shopping page, the process resolves back to step 701. However, if the consumer does not proceed to checkout and does not wish to return to the shopping page, the process ends and no update is made to the consumer's points balance. If the consumer proceeds to checkout and completes the transaction at step 707, the system updates the consumer's points balance at step 709. The system performs this operation routinely after each action or transaction that is completed by a consumer involving earned and or applied points. If the consumer applied points to a transaction and or earned points, the consumer's account data is updated with the latest accounting of the consumer's points Likewise, the process may be applied to web-based actions performed by consumers where points are earned. At completion of such actions, the consumer account data is updated to reflect the new points total. The process ends at step 710.

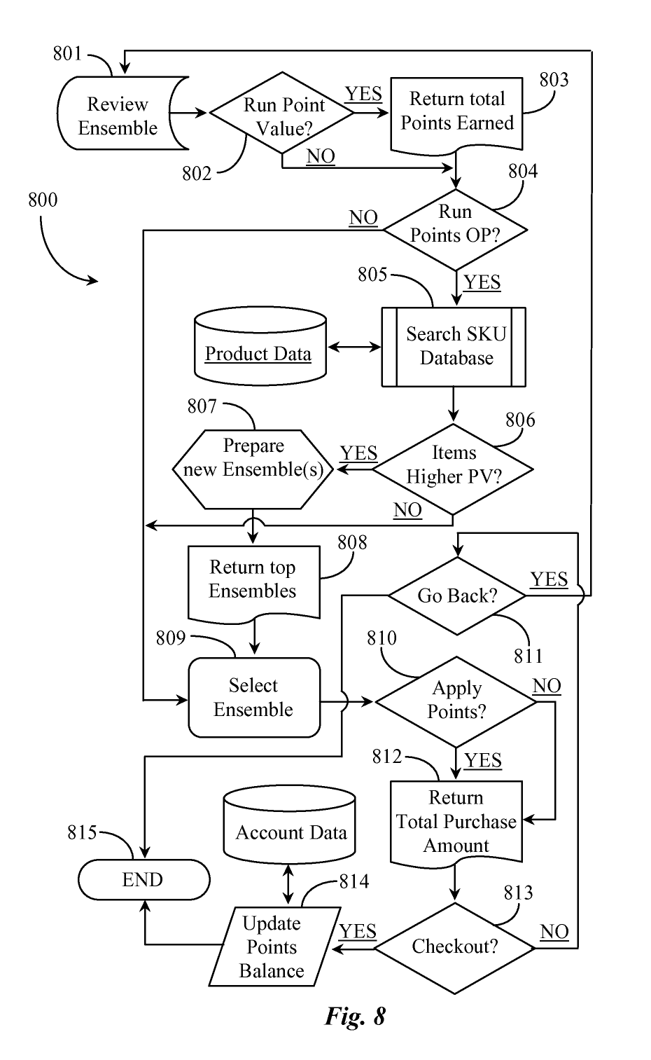

FIG. 8 is a process flow chart 800 illustrating steps for comparing point values of similar products to optimize points earned. It is assumed in this example, that a consumer is logged into and connected to the supporting website, in this case, a fashion website that sells items individually and in logical groupings based on fashion sense. At step 801, the consumer reviews an ensemble containing two or more fashion items. An example of an ensemble might be a grouping of items including a dress, handbag, and a pair of shoes that go together in a fashion sense. In one embodiment, the ensemble is one put together by the system, such as by a fashion consultant or other knowledgeable and authorized individual working for the company hosting the website. In another embodiment, the ensemble may be put together by the consumer.

At step 802, the consumer may make a determination whether to run a point value calculation. A point value calculation calculates the total of points that would be earned if the ensemble were purchased. In one aspect of the process, calculation and display of earnable points associated with purchasing the ensemble is automated and is displayed for the consumer in a manner that is convenient to the consumer such as in the same window that the items of the ensemble are displayed in. In this example, the consumers run their own Points values on products assembled for purchase whether the purchase is for a single product or for a group of products.

If the consumer determines to run a Points value operation at step 802, the system returns at least the total figure for all of the earnable points for the ensemble should the consumer purchase the ensemble. In one embodiment, there are points associated with each item in the ensemble and there are bonus points for buying all of the items in one transaction. In one embodiment, the system may also return itemized point values for each item and any points that are earnable for the grouping of items. If the consumer determines not to run point value at step 802, the process skips to step 804.

At step 804, the consumer makes a determination whether to run Points optimization. A points optimization task compares items in the ensemble of step 801 with other items available for purchase that could be swapped for items in the ensemble to gain a higher points count for earnable points should the ensemble be purchased with the new items. If the consumer determines not to run points optimization in step 804, the process may skip to step 809. If the consumer determines to run Points optimization at step 804, then a points optimization engine analogous to engine 604 (FIG. 6) may search a product database at step 805, the products uniquely defined by SKU numbers.

At step 806, the system (optimization engine) determines if there are any items available for purchase that have a higher earned point value than similar items in the ensemble of step 801 that could replace similar items in the ensemble of step 801. The optimization engine has access to all of the product descriptions for all of the items available for purchase and to fashion logic, which aids the system in selecting items that would compliment the other items in the ensemble. Therefore, the system can select items for replacement that, in addition to having a higher point value, are of the same size, the same or coordinated color pattern, the same or matching style, and that are comparatively priced to items in the ensemble of step 801. In one embodiment, the consumer may set a price cap for items in the original ensemble such as a maximum increase in price for any replacement item.

If the system determines that there are comparatively priced items available that have higher points values for earnable points than those items in the ensemble of step 801, the system prepares one or more new ensembles at step 807. A new ensemble may include one or more replacement items. Likewise, a new ensemble may retain one or more of the original items. At step 808, the system returns the top rated ensembles by order of total point optimization as a default. The one or more new ensembles put together by the system are displayed along side the ensemble of step 801. In this way, the consumer may visually compare the ensembles to determine which one to select for purchase.

If at step 806, the system determines that there are no items available that have higher point values that could be swapped for items in the original ensemble of step 801, the process may skip to step 809. At step 809, the consumer selects an ensemble for purchase. If there were no items having higher point values that could have been replacements for items in the original ensemble, the consumer selects the original ensemble for purchase at step 809. If there were one or more new ensembles for the consumer to consider, then the consumer may select any of the new ensembles for purchase or may simply decide to stay with the original ensemble despite the points value increases.

The consumer is given an option of whether to apply existing points to the pending purchase price resulting in a discount. Existing points may include any points that might be allotted the consumer for the pending purchase. It is noted herein that the transaction must be completed in order to apply points from the consumer account toward the purchase, including any points that might be earned from the transaction. The process moves to step 812 regardless of whether the consumer applies any points to the transaction. At step 812, the system returns the total purchase amount to the consumer. The consumer may then decide whether to proceed to checkout at step 813.

If the consumer decides not to purchase the selected ensemble at step 812, the consumer may be given the option of going back to the shopping page at step 811, to browse more items including ensembles. If the consumer determines at step 811 to go back, the process resolves back to the beginning at step 801. However, if the consumer determines not to go back at step 811, the process for the consumer ends at step 815. If the consumer decides to proceed to checkout at step 813, the consumer completes the transaction on the checkout page accordingly and the consumer's points account is updated at step 814. Points earned for the transaction are added to the consumer's points account balance and any applied points are deducted from the consumer's points account balance. The process then ends for the consumer at step 815. In one embodiment, the consumer may go back at any time during the process and start over with or without completing a transaction.

It will be apparent to one with skill in the art that the automated Points incentive system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A method for incentivizing network-connected consumers patronizing a network-hosted shopping site comprising the steps:
(a) establishing a ratio between points and monetary credit;
(b) assigning points to individual product representations, product groupings, and web-based actions performed by consumers;
(c) creating point value accounts for qualified consumers;
(d) tracking actions and transactions completed by consumers;
(e) calculating accounting data relative to point accumulation and consumption by consumers resulting from the actions and transactions of step (d); and
(f) displaying the data in summary form to the consumers.

2. The method of claim 1, wherein the network is the Internet network.

3. The method of claim 1, wherein in step (a), monetary credit is expressed in US currency.

4. The method of claim 1, wherein in step (b), individual product representations are denoted by stock keeping units (SKUs).

5. The method of claim 1, wherein in step (b), the product groupings are logical groupings of product representations.

6. The method of claim 1, wherein in step (b), web-based actions include completing transactions, member referrals, consumer registrations, consumer video appearances, consumer reviews, and consumer navigation tasks.

7. The method of claim 1, wherein in step (c), the created accounts are linked to one or more consumer interfacing applications operated by identified consumers.

8. The method of claim 1, wherein in step (d), actions and transactions are tracked in real time as they occur.

9. The method of claim 1, wherein in step (e), the data is rendered in objective fashion in cases of actual actions and transactions completed, and in predictive fashion in cases of contemplated actions and transactions.

10. The method of claim 1, wherein in step (f), the data is displayed in one or more of a Website, a video, a product page, a checkout page, a popup notification and, an electronic message.

11. A system for incentivizing network-connected consumers patronizing a network-hosted shopping site comprising:
an Internet-connected server;
software executing on the server from a non-transitory physical medium, the software providing functions for:
tracking web-based actions completed by consumers;
calculating account data relative to accumulation and consumption by consumers of points equated to monetary credit, the points assigned in specified amounts to individual product representations, product groupings, and web-based actions; and
displaying the data in summary form to consumers.

12. The system of claim 11, wherein monetary credit is expressed in US currency.

13. The system of claim 11, wherein web-based actions include completing transactions, member referrals, consumer registrations, consumer video appearances, consumer reviews, and consumer navigation tasks.

14. The system of claim 11, wherein the data is displayed in one or more consumer interfacing applications operated by identified consumers.

15. The system of claim 11, wherein the web-based actions and transactions are tracked in real time as they occur.

16. The system of claim 11, wherein individual product representations are denoted by stock keeping units (SKUs).

17. The system of claim 11, wherein the product groupings are logical groupings of product representations.

18. The system of claim 14, wherein the consumer interfacing applications include one or more of a Website, a video, a product page, a checkout page, a popup notification and, an electronic message.

19. The system of claim 11, wherein the software includes a further function for calculating account data relative to accumulation and consumption by consumers of points equated to monetary credit, the points assigned in specified amounts to individual product representations, product groupings, and web-based actions that are contemplated, but not yet undertaken, the calculation serving as an ordered prediction of monetary credit relative to the contemplated web-based actions.

20. The system of claim 19, wherein the web-based actions are contemplated transactions to purchase one or more products.
